(19) United States
(12) Patent Application Publication
(10) Pub. No.: US 2021/0257782 A1
(43) Pub. Date: Aug. 19, 2021

(54) Hand-Held Processing Device and Method for Producing a Hand-Held Processing Device

(71) Applicant: Andreas Stihl AG & Co. KG, Waiblingen (DE)

(72) Inventor: Martin FAILENSCHMID, Stuttgart (DE)

(21) Appl. No.: 17/175,121

(22) Filed: Feb. 12, 2021

(30) Foreign Application Priority Data
Feb. 14, 2020 (EP) 20157349.0

(51) Int. Cl. H01R 13/639; H01R 13/621; H01R 43/26; H02K 5/22; H02K 11/33; B25F 5/02

(52) U.S. Cl. CPC H01R 13/639; H01R 13/621; B25F 5/02; H02K 5/225; H02K 11/33; H01R 43/26

(57) ABSTRACT

A hand-held processing device has an electric drive motor system with a first power part and a second power part. The first power part has a first power connector and the second power part has a second power connector. The first and second power connectors are designed for electric connection to one another for transferring electric driving power. A device housing has first and second housing parts. The first housing part and the first power part are connected mechanically to one another and the second housing part and the second power part are connected mechanically to one another. The first housing part, with the mechanically connected first power part, and the second housing part, with the mechanically connected second power part, are designed for mechanical connection to one another for the arrangement of the electric drive motor system in the device housing. The first power connector is held fast in such a way in relation to the first housing part and the second power connector is held fast in such a way in relation to the second housing part that, by means of arrangement of the first housing part, with the mechanically connected first power part, and of the second housing part, with the mechanically connected second power part, against one another for mechanical connection to one another, the first power connector and the second power connector are arranged adjacent to one another. The electric drive motor system has at least one fixing element designed to be adjustable between an enable position for enabling the arrangement of the first power connector and the second power connector adjacent to one another and a fixing position for the fixing of the electric connection of the first power connector and the second power connector to one another.

### CROSS REFERENCE TO RELATED APPLICATION

This application claims priority under 35 U.S.C. § 119 from European Patent Application No. 20157349.0, filed Feb. 14, 2020, the entire disclosure of which is herein expressly incorporated by reference.

### BACKGROUND AND SUMMARY OF THE INVENTION

The invention relates to a hand-held processing device and to a method for producing a hand-held processing device of this kind.

The problem addressed by the invention is that of providing a hand-held processing device and a method for producing a hand-held processing device of this kind, each of which has improved characteristics.

The invention solves the problem through the provision of a hand-held processing device and/or a method having the features of the independent claims. The dependent claims describe advantageous developments and/or embodiments of the invention.

The hand-held processing device according to the invention comprises or has an electric drive motor system and a device housing. The electric drive motor system comprises or has a first, in particular electric, power part and a second power part, in particular a second power part which is electric and/or different from the first power part. The first power part comprises or has at least one, in particular mechanical, first power connector. The second power part comprises or has at least one second power connector, in particular a second power connector which is mechanical and/or different from the first power connector. The first power connector and the second power connector are designed or configured for electric connection, in particular electric contacting, to one another, in particular direct or indirect and/or releasable, in particular nondestructively releasable, electric connection or contacting, in order to transfer electric driving power. The device housing comprises or has a first housing part and a second housing part. The first housing part and the first power part are connected or preassembled mechanically to or with one another, in particular directly. The second housing part and the second power part are connected or preassembled mechanically to or with one another, in particular directly. Furthermore, the first housing part, with the mechanically connected first power part, and the second housing part, with the mechanically connected second power part, are designed or configured for mechanical connection or assembly to one another, in particular direct/and or releasable, in particular nondestructively releasable, connection or assembly to one another, for arrangement or reception or surrounding, in particular at least partial, in particular complete, arrangement or reception or surrounding of the electric drive motor system in the device housing. Moreover, the first power connector is held fast, in particular held and/or fastened in a fixed location, in such a way in relation to the first housing part, in particular on the first housing part, and the second power connector is held fast, in particular held and/or fastened in a fixed location, in such a way in relation to the second housing part, in particular on the second housing part, that, by means of arrangement or fitting of the first housing part, in particular only by means of arrangement or fitting of the first housing part, with the mechanically connected first power part, and of the second housing part, with the mechanically connected second power part, against one another for mechanical connection to one another, the first power connector and the second power connector are arranged adjacent to one another. Furthermore, the electric drive motor system comprises or has at least one, in particular mechanical, fixing element or securing element. The fixing element is designed or configured to be adjustable, in particular directly adjustable, in particular user-adjustable, between, in particular from, an enable position for enabling the arrangement of the first power connector and of the second power connector adjacent to one another and, in particular to, a fixing position or securing position, in particular a fixing position or securing position different from the enable position, for the fixing or securing, in particular direct fixing or securing, of the electric connection of the first power connector and of the second power connector to one another.

This, in particular the arrangement of the first power connector and of the second power connector adjacent to one another by arranging the first housing part and the second housing part against one another, allows simple and/or reliable production or assembly of the processing device. In addition, this, in particular the fixing element, allows reliable transfer of electric driving power and/or a low transfer resistance.

In particular, the hand-held processing device (German: hand-geführtes Bearbeitungsgerät, guided by hand) can be a hand-portable processing device (German: hand-getragenes Bearbeitungsgerät, carried in the hand/s). In addition or as an alternative, hand-held, in particular hand-portable, processing device can mean that the processing device can have a mass of at most 50 kilograms (kg), in particular of at most 20 kg, in particular of at most 10 kg, in particular of at most 5 kg, and/or of at least 1 kg, in particular of at least 2 kg. As a further addition or alternative, the processing device can be a gardening, forestry and/or construction processing device. In particular, the gardening, forestry and/or construction processing device can be a saw, a brushcutter or a cut-off grinder.

The processing device can have a processing tool, wherein the electric drive motor system can be designed to drive the processing tool, in particular through the electric connection of the first power connector and of the second power connector to one another.

The first power connector and the second power connector can each be referred to as a motor phase. In addition or as an alternative, the first power connector and the second power connector can be designed for a maximum operating current of at least 25 amperes (A), in particular of at least 50 A, and/or of at most 200 A, in particular of at most 150 A, in particular 100 A. As a further addition or alternative, the electric drive motor system can have a further power part.

The device housing can have a further housing part. In addition or as an alternative, the device housing can be an outer housing and/or can be enclosed. As a further addition or alternative, the first housing part can be a first outer housing part and/or a first housing shell, and/or the second housing part can be a second outer housing part and/or a second housing shell.

Without or before the arrangement of the first housing part and the second housing part against one another, the first power connector and the second power connector need not or cannot be connected electrically to one another and/or arranged adjacent to one another. In addition or as an alternative, arranged adjacent to one another can mean at most 5 millimetres (mm), in particular at most 2 mm, in particular at most 1 mm, in particular 0 mm, from one another. As a further addition or alternative, the first power connector and the second power connector can be connected electrically to one another by and/or after arranging, in particular only by and/or after arranging, the first housing part and the second housing part against one another.

The first power connector and the second power connector can be connected electrically to one another by adjusting, in particular only by adjusting, the fixing element between the enable position and the fixing position. In addition or as an alternative, the first power connector and the second power connector need not or cannot be connected electrically to one another without or before the adjustment of the fixing element between the enable position and the fixing position. As a further addition or alternative, it is not necessary or not possible, in the fixing position, for the fixing element to enable the arrangement of the first power connector and of the second power connector adjacent to one another. As a further addition or alternative, the fixing element can be designed to be adjustable, in particular user-adjustable, in particular nondestructively, from the fixing position to the enable position. As a further addition or alternative, the first power part and/or the second power part can have the fixing element.

In a development of the invention, the first power connector is held fast in such a way and the second power connector is held fast in such a way that, by means of the arrangement, in particular only by means of the arrangement, of the first housing part and of the second housing part against one another, the first power connector and the second power connector are arranged in contact with one another and/or in each case in contact with the fixing element. In addition or as an alternative, the first power connector is held fast in such a way and the second power connector is held fast in such a way that, by means of the adjustment, in particular only by means of the adjustment, of the fixing element between the enable position and the fixing position, the first power connector and the second power connector are arranged in contact with one another and/or in each case in contact with the fixing element. This allows particularly simple and/or particularly reliable production of the processing device. In particular, the first power connector and the second power connector are connected to one another electrically by means of the fixing element. In addition or as an alternative, the fixing element can touch the first power connector and/or the second power connector in the fixing position. As a further addition or alternative, the fixing element can fix the electric connection by nonpositive engagement and/or positive engagement in the fixing position. As a further addition or alternative, the arrangement of the first power connector and of the second power connector adjacent to one another and/or the electric connection of the first power connector and of the second power connector to one another need not or may not be a plug connection.

In a development of the invention, the fixing element is not designed or configured for adjustment between the enable position and the fixing position by the arrangement of the first housing part and the second housing part against one another and/or of the first power connector and the second power connector adjacent to one another.

In particular, the fixing element need not or may not be a snap-fit element.

In a development of the invention, the fixing element has a screw, in particular the fixing element is a screw. This allows particularly reliable transfer of electric driving power and/or a particularly low transfer resistance.

In a development of the invention, the first power connector has insertion prongs for the reception of a part of the fixing element in the enable position, in particular during arrangement. In addition or as an alternative, the second power connector has insertion prongs for the reception of a part of the fixing element in the enable position, in particular during arrangement. This allows particularly simple and/or particularly reliable production of the processing device.

In a development of the invention, the first power connector and the fixing element are designed or configured in such a way that the first power connector, in particular the arranged first power connector, and the fixing element are secured against release from one another in the fixing position by positive engagement, in particular directly with one another. In addition or as an alternative, the second power connector and the fixing element are designed or configured in such a way that the second power connector, in particular the arranged second power connector, and the fixing element are secured against release from one another in the fixing position by positive engagement, in particular directly with one another. This allows particularly reliable transfer of electric driving power.

In a development of the invention, the device housing has a closable, in particular user-closable, access opening for electrically connecting the first power connector and the second power connector to one another and/or for adjusting the fixing element, in particular with the first housing part and the second housing part arranged against one another. In particular, the device housing can have a third housing part, in particular a cover, for closing the access opening. In addition or as an alternative, the access opening can be an external access opening.

In a development of the invention, the first housing part and the second housing part are designed or configured for arrangement against one another in an arrangement direction. In addition, the fixing element is designed or configured to be adjustable between the enable position and the fixing position in an adjustment direction nonparallel, in particular orthogonal, to the arrangement direction. As a further addition or alternative, the first power connector has a first, in particular flat, contact surface, and the second power connector has a second, in particular flat, contact surface for electric connection, in particular direct electric connection, to one another. The first contact surface of the first power connector is aligned non-orthogonally, in particular parallel, to the arrangement direction, and the second contact surface of the second power connector is aligned non-orthogonally, in particular parallel, to the arrangement direction. This allows simple adjustment of the fixing element and/or simple arrangement of the first power connector and of the second power connector adjacent to one another.

In one embodiment of the invention, the first contact surface of the first power connector is aligned in such a way and the second contact surface of the second power connector is aligned in such a way that, owing to the arrangement, in particular only owing to the arrangement, of the first housing part and of the second housing part against one another, the first contact surface and the second contact surface overlap in an overlap direction non-orthogonal, in particular parallel, to the arrangement direction, in particular overlap parallel to one another. This allows particularly good, in particular more reliable, electric connection and thus particularly good, in particular reliable, transfer of electric driving power. In particular, the first contact surface and the second contact surface are arranged in series in the adjustment direction.

In a development of the invention, the first power connector has a first contact tongue, in particular the first power connector is a first contact tongue. In addition or as an alternative, the second power connector has a second contact tongue, in particular the second power connector is a second contact tongue. This allows simple arrangement of the first power connector and of the second power connector adjacent to one another and/or simple electric connection of the first power connector and of the second power connector to one another and/or simple fixing of the electric connection.

In a development of the invention, the processing device comprises or has a sensor system, in particular an electric sensor system. The sensor system comprises or has a first sensor part, in particular an electric first sensor part, and a second sensor part, which is, in particular electric and/or different from the first sensor part. The first sensor part comprises or has at least one, in particular mechanical, first sensor connector. The second sensor part comprises or has at least one second sensor connector, in particular a second sensor connector which is mechanical and/or different from the first sensor connector. The first sensor connector and the second sensor connector are designed or configured for electric connection, in particular electric contacting, to one another, in particular direct or indirect and/or releasable, in particular nondestructively releasable, electric connection or contacting, in order to transfer an electric sensor signal. The first housing part and the first sensor part are connected or preassembled mechanically to or with one another, in particular directly. The second housing part and the second sensor part are connected or preassembled mechanically to or with one another, in particular directly. Furthermore, the first housing part, with the mechanically connected first sensor part, and the second housing part, with the mechanically connected second sensor part, are designed or configured for mechanical connection to one another for arrangement or reception or surrounding, in particular at least partial, in particular complete, arrangement or reception or surrounding of the sensor system in the device housing. Moreover, the first sensor connector is held fast, in particular held and/or fastened in a fixed location, in such a way in relation to the first housing part, in particular on the first housing part, and the second sensor connector is held fast, in particular held and/or fastened in a fixed location, in such a way in relation to the second housing part, in particular on the second housing part, that, by means of the arrangement of the first housing part, in particular only by means of the arrangement of the first housing part, with the mechanically connected first sensor part, and of the second housing part, with the mechanically connected second sensor part, against one another for mechanical connection to one another, the first sensor connector and the second sensor connector are arranged adjacent to one another. This allows simple and/or reliable production of the processing device. In particular, the sensor system can be designed to record a measured variable of the electric drive motor system and/or of the processing tool, where present, in particular by means of the electric connection of the first sensor connector and of the second sensor connector to one another. In particular, the sensor system can be a temperature sensor system and/or an oil sensor system. In addition or as an alternative, the sensor system can have a further sensor part. Without or before the arrangement of the first housing part and the second housing part against one another, the first sensor connector and the second sensor connector need not or cannot be connected electrically to one another and/or arranged adjacent to one another. As a further addition or alternative, the first sensor connector and the second sensor connector can be connected electrically to one another by and/or after arranging, in particular only by and/or after arranging, the first housing part and the second housing part against one another. As a further addition or alternative, the arrangement of the first sensor connector and of the second sensor connector adjacent to one another and/or the electric connection of the first sensor connector and of the second sensor connector to one another must or may be a plug connection.

In a development, in particular one embodiment, of the invention, the first power part comprises or has an electric motor. In addition or as an alternative, the second power part comprises or has an electronic motor control system and/or power electronics, in particular an inverter and/or at least one circuit breaker, in particular a power transistor, and/or a power source interface, in particular a rechargeable battery interface, for electric connection, in particular electric contacting, to a power source, in particular an external power source, in particular a rechargeable battery pack, for supplying the processing device with electric driving power. As a further addition or alternative, the first sensor part, where present, comprises or has a sensor element for recording a measured variable, in particular a physical measured variable, in particular a value of the measured variable. As a further addition or alternative, the second sensor part, where present, comprises or has sensor electronics for processing, in particular further processing, an electric sensor signal, in particular the electric sensor signal. In particular, the sensor signal can comprise information on the measured variable.

In a development of the invention, the first housing part is at least 50 percent (%), in particular 100%, made of metal. In addition or as an alternative, the second housing part is at least 50%, in particular 100%, made of, electrically insulating, plastic. This, in particular metal, makes possible a high strength, in particular and therefore good fastening of the electric motor, where present. In addition or as an alternative, this, in particular plastic, makes possible good insulation of the electronic motor control system and/or of the power electronics and/or of the power source interface, where present, and/or a low weight.

In a development of the invention, the first housing part and the second housing part are designed or configured for arrangement against one another in an arrangement direction nonparallel, in particular orthogonal, to a longitudinal axis of the processing device. This allows particularly simple production of the processing device. In particular, the longitudinal axis can correspond to, in particular be identical to, a longitudinal axis of the processing device, where present.

The method according to the invention for producing or assembling a, in particular the, hand-held processing device as described above comprises or has the following steps: a) arranging the first housing part, with the mechanically connected first power part, and the second housing part, with the mechanically connected second power part, against one another, and b) adjusting the fixing element between the enable position and the fixing position. In particular, step b) may not be carried out before step a). In addition or as an alternative, step b) may be carried out after step a). As a further addition or alternative, the method can have further steps.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a hand-held processing device according to the invention before arrangement of a first housing part and of a second housing part against one another,

FIG. 2 shows the processing device in FIG. 1 during the arrangement or during arrangement of the first housing part and of the second housing part against one another in a method according to the invention for producing the processing device,

FIG. 3 shows the processing device in FIG. 1 after the arrangement of the first housing part and of the second housing part against one another and before adjustment of a fixing element between an enable position and a fixing position,

FIG. 4 shows the processing device in FIG. 1 during the adjustment or during adjustment of the fixing element between the enable position and the fixing position of the method for producing the processing device,

FIG. 5 shows the processing device in FIG. 1 after the adjustment of the fixing element between the enable position and the fixing position,

FIG. 6 shows a front view of the processing device in FIG. 1 with an access opening opened,

FIG. 7 shows a front view of the processing device in FIG. 1 with the access opening closed,

FIG. 8 shows a side view of the processing device in FIG. 1,

FIG. 9 shows schematically the processing device in FIG. 1 before the arrangement of the first housing part and of the second housing part against one another, and

FIG. 10 shows schematically the processing device in FIG. 1 after the arrangement of the first housing part and of the second housing part against one another.

### DETAILED DESCRIPTION OF THE DRAWINGS

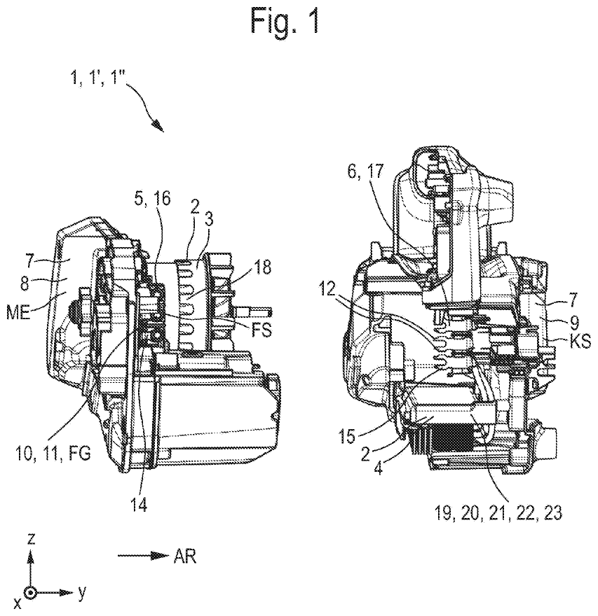

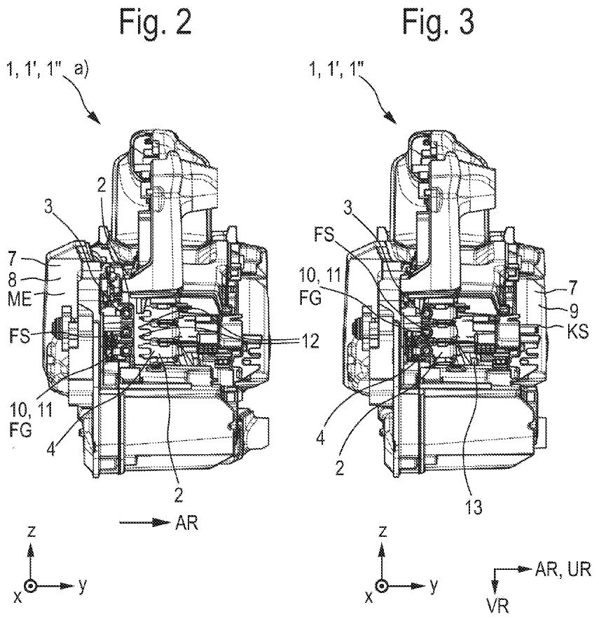

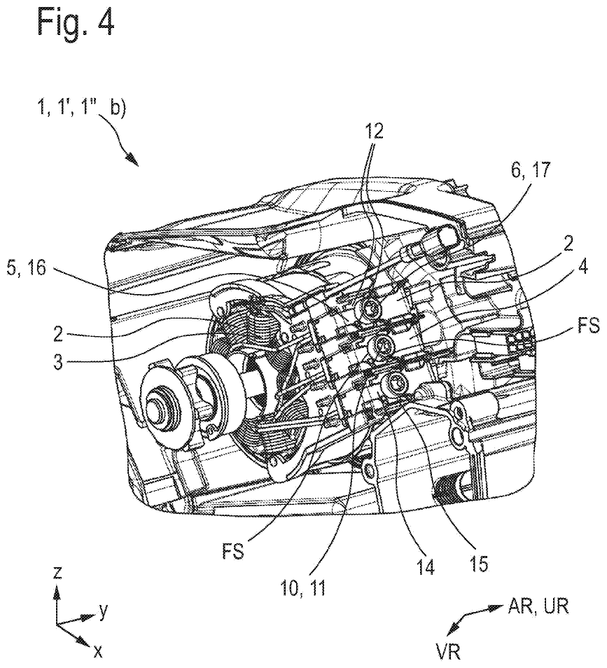

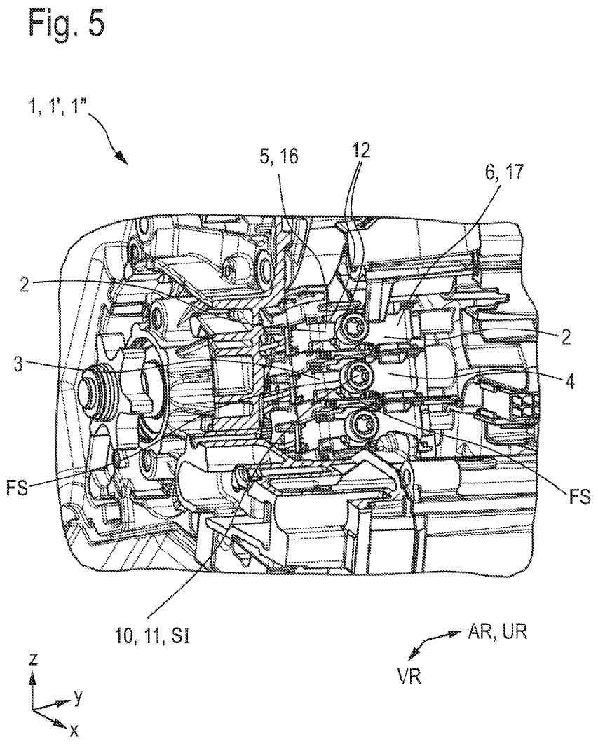

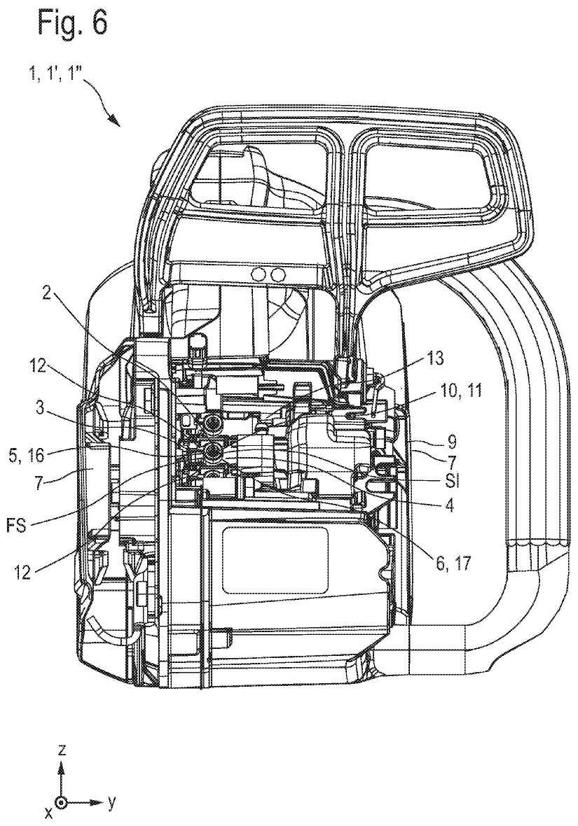

FIGS. 1 to 10 show a hand-held processing device 1 according to the invention. The processing device 1 has an electric drive motor system 2 and a device housing 7. The electric drive motor system 2 has a first power part 3 and a second power part 4. The first power part 3 has at least one first power connector 5, three first power connectors 5 in the exemplary embodiment shown. The second power part 4 has at least one second power connector 6, three second power connectors 6 in the exemplary embodiment shown. The first power connector 5—all the first power connectors 5 in the exemplary embodiment shown—and the second power connector 6—all the second power connectors 6 in the exemplary embodiment shown—are designed for electric connection to one another, in particular allocated or pairwise electric connection to one another, for the transfer of electric driving power, being electrically connected in FIGS. 5 to 8. The device housing 7 has a first housing part 8 and a second housing part 9. The first housing part 7 and the first power part 3 are connected mechanically to one another, in particular directly, as shown in FIGS. 1 and 2. The second housing part 9 and the second power part 4 are connected mechanically to one another, in particular directly. Furthermore, the first housing part 8, with the mechanically connected first power part 3, and the second housing part 9, with the mechanically connected second power part 4 are designed for mechanical connection, in particular direct mechanical connection, to one another for the arrangement of the electric drive motor system in the device housing, being mechanically connected and arranged in FIGS. 3 to 8 and 10. Moreover, as shown in FIGS. 1 to 6, the first power connector 5—all the first power connectors 5 in the exemplary embodiment shown are—is held fast in such a way in relation to the first housing part 8, and the second power connector 6—all the second power connectors 6 in the exemplary embodiment shown are—is held fast in such a way in relation to the second housing part 9 that, by means of arrangement of the first housing part 8, with the mechanically connected first power part 3, and of the second housing part 9, with the mechanically connected second power part 4, against one another for mechanical connection to one another, the first power connector 5—all the first power connectors 5 in the exemplary embodiment shown—and the second power connector 6—all the second power connectors 6 in the exemplary embodiment shown—are arranged adjacent to one another, in particular in an allocated or pairwise manner, as shown in FIG. 3. Furthermore, the electric drive motor system 2—the first power part 3 in the exemplary embodiment shown—has at least one fixing element 10—three fixing elements 10 in the exemplary embodiment shown. The fixing element 10—each of the fixing elements 10 in the exemplary embodiment shown—is designed to be adjustable between an enable position FG for enabling the arrangement of the first power connector 5, in particular the allocated first power connector, and of the second power connector 6, in particular the allocated second power connector, adjacent to one another, as shown in FIGS. 1 to 3, and a fixing position SI for fixing the electric connection of the first power connector 5, in particular the allocated first power connector, and of the second power connector 6, in particular the allocated second power connector, to one another, as shown in FIGS. 5 and 6.

In the exemplary embodiment shown, a number of first power connectors 5 and a number of second power connectors 6 correspond, in particular are identical, to one another. In addition, a number of fixing elements 10 corresponds, in particular is identical, to the number of first power connectors 5 and/or to the number of second power connectors 6. In alternative exemplary embodiments, this may be different. In particular, the first power part and the second power part may each have just one single power connector, precisely two power connectors or at least four power connectors. In addition or as an alternative, the electric drive motor system can have just a single fixing element, precisely two fixing elements or at least four fixing elements. As a further addition or alternative, a number of fixing elements need not or may not correspond to the number of first power connectors and/or to the number of second power connectors.

The method according to the invention for producing the hand-held processing device 1 has the following steps: a) arranging the first housing part 8, with the mechanically connected first power part 3, and the second housing part 9, with the mechanically connected second power part 4, against one another, as shown in FIG. 2, and b) adjusting the fixing element 10 between the enable position FG and the fixing position SI.

In the exemplary embodiment shown, the method furthermore has the following step: mechanically connecting the first housing part 8 and the second housing part 9 to one another, in particular after step a). In alternative exemplary embodiments, mechanical connection can be carried out simultaneously with arrangement, in particular by means of arrangement.

In the exemplary embodiment shown, the method furthermore has the following step: electric connection, in particular reliable electric connection, of the first power connector 5 and of the second power connector 6 to one another, in particular by the adjustment of the fixing element 10 between the enable position FG and the fixing position SI. In alternative exemplary embodiments, the electric connection, in particular reliable electric connection, of the first power connector and of the second power connector to one another can be carried out in a different way, in particular by arranging the first housing part and the second housing part against one another.

Moreover, in the exemplary embodiment shown, the processing device 1 is a saw 1′, in particular a chainsaw 1″.

In the exemplary embodiment shown, the processing device 1 furthermore has a processing tool 30, in the exemplary embodiment shown in the form of a sawing processing tool 30′, in particular of a saw chain 30″.

The electric drive motor system 2 is designed to drive the processing device 30, in particular by means of the electric connection of the first power connector 5 and of the second power connector 6 to one another.

In detail, the first power connector 5 is held fast in such a way and the second power connector 6 is held fast in such a way that, by means of the arrangement of the first housing part 8 and the second housing part 9 against one another, the first power connector 5 and the second power connector 6 are arranged in contact with one another and/or in each case in contact with the fixing element 10.

In addition, the first power connector 5 is held fast in such a way and the second power connector 6 is held fast in such a way that, in particular at the latest, by means of the adjustment of the fixing element 10 between the enable position FG and the fixing position SI, the first power connector 5 and the second power connector 6 are arranged in contact with one another and/or in each case in contact with the fixing element 10.

Moreover, the fixing element 10 is not designed for adjustment between the enable position FG and the fixing position SI by the arrangement of the first housing part 8 and the second housing part 9 against one another and/or of the first power connector 5 and the second power connector 6 adjacent to one another.

Furthermore, the fixing element 10 has a screw 11, in particular the fixing element 10 is a screw 11.

In the exemplary embodiment shown, the adjustment of the fixing element 10 between the enable position FG and the fixing position SI comprises screwing in the screw 11, in particular is screwing it in.

In addition, the second power connector 6 has insertion prongs 12, in particular insertion prongs extending in an arrangement direction AR, for the reception of a part of the fixing element 10—in the exemplary embodiment shown of a shank of the screw 11—in the enable position SI, in particular during arrangement, the part having been received in FIGS. 3 to 8.

In the exemplary embodiment shown, the first power connector 5 furthermore has a through hole for passing through the part of the fixing element 10 in the enable position SI, in particular and in the fixing position SI, the part having been passed through in FIGS. 1 to 8.

In alternative exemplary embodiments, it is additionally or alternatively possible for the first power connector to have insertion prongs for the reception of a part of the fixing element in the enable position, in particular during arrangement.

Moreover, the first power connector 5 and the fixing element 10 are designed in such a way that the first power connector 5, in particular the arranged first power connector, and the fixing element 10 are secured against release from one another, in particular counter to the arrangement direction AR, in the fixing position SI, in particular and in the enable position FG, by positive engagement FS—in the exemplary embodiment shown between a circumferential edge of the through hole of the first power connector 5 and a circumferential edge of the part of the fixing element 10.

In addition, the second power connector 6 and the fixing element 10 are designed in such a way that the second power connector 6, in particular the arranged second power connector, and the fixing element 10 are secured against release from one another, in particular counter to the arrangement direction AR, in the fixing position SI by positive engagement FS—in the exemplary embodiment shown between an end, in particular a bent end, of one of the insertion prongs 12 of the second power connector 6 and a circumferential edge of a head of the screw 11.

Furthermore, the device housing 7 has a closable access opening 13 for electrically connecting the first power connector 5 and the second power connector 6 to one another and/or for adjusting the fixing element 10, in particular with the first housing part 8 and the second housing part 9 arranged against one another, as shown in FIG. 6.

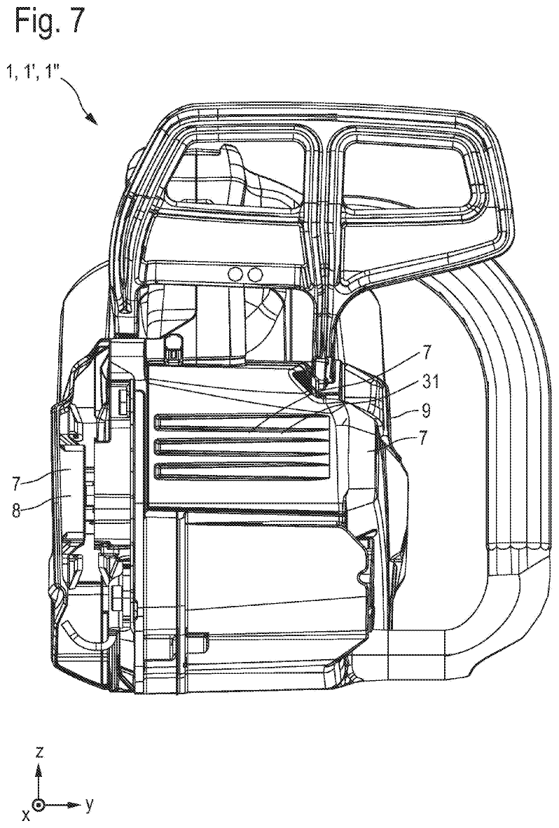

In the exemplary embodiment shown, the device housing 7 has a third housing part 31 for closing the access opening 13, the opening being closed in FIG. 7.

In the exemplary embodiment shown, the method furthermore has the following step: closing the access opening 13, in particular after the electric connection of the first power connector 5 and of the second power connector 6 to one another and/or after the adjustment of the fixing element 10.

Furthermore, the first housing part 8 and the second housing part 9 are designed for arrangement against one another in the arrangement direction AR, in the exemplary embodiment shown in direction y.

In addition, the fixing element 10 is designed to be adjustable between the enable position FG and the fixing position SI in an adjustment direction VR nonparallel, in particular orthogonal, to the arrangement direction AR, in the exemplary embodiment in direction −x-z.

As a further addition, the first power connector 5 has a first contact surface 14, and the second power connector 6 has a second contact surface 15 for electric connection to one another. The first contact surface 14 of the first power connector 5 is aligned non-orthogonally, in particular parallel, to the arrangement direction AR, and the second contact surface 15 of the second power connector 6 is aligned non-orthogonally, in particular parallel, to the arrangement direction AR.

In detail, the first contact surface 14 of the first power connector 5 is aligned in such a way and the second contact surface 15 of the second power connector 6 is aligned in such a way that, owing to the arrangement of the first housing part 8 and of the second housing part 9 against one another, the first contact surface 14 and the second contact surface 15 overlap in an overlap direction UR non-orthogonal, in particular parallel, to the arrangement direction AR, in the exemplary embodiment shown in direction y, in particular overlap parallel to one another.

In alternative exemplary embodiments, the first contact surface and the second contact surface must or may be arranged as an extension one of the other in the arrangement direction and/or need not or may not overlap owing to the arrangement of the first housing part and of the second housing part against one another. In particular, the first power connector and the second power connector are connected to one another electrically by means of the fixing element.

Moreover, the first power connector 5 has a first contact tongue 16, in particular the first power connector 5 is a first contact tongue 16.

In addition, the second power connector 6 has a second contact tongue 17, in particular the second power connector 6 is a second contact tongue 17.

In the fixing position SI in the exemplary

exemplary embodiment shown, the fixing element 10, in particular in the form of the screw 11, in particular the head of the screw 11, exerts a force on, in particular presses or clamps, the first power connector 5, in particular in the form of the first contact tongue 16, in particular the first contact surface 14 of the first power connector 5, and the second power connector 6, in particular in the form of the second contact tongue 17, in particular the second contact surface 15 of the second power connector 6, into contact with one another, in particular in the adjustment direction VR.

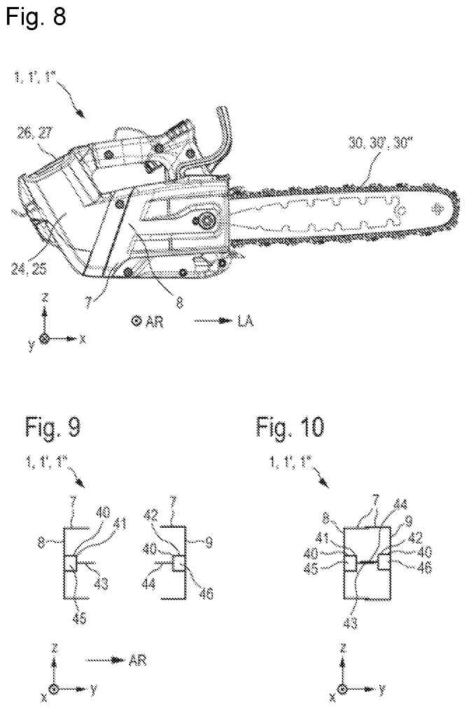

Furthermore, the first housing part 8 and the second housing part 9 are designed for arrangement against one another in the arrangement direction AR, which is nonparallel, in particular orthogonal, to a longitudinal axis LA, in the exemplary embodiment shown in direction x, of the processing device 1, as shown in FIG. 8.

In the exemplary embodiment shown, the arrangement direction AR is horizontal.

The processing device 1 furthermore has a sensor system 40. The sensor system 40 has a first sensor part 41 and a second sensor part 42. The first sensor part 41 has at least one first sensor connector 43. The second sensor part 42 has at least one second sensor connector 44. The first sensor connector 43 and the second sensor connector 44 are designed for electric connection to one another in order to transfer an electric sensor signal, being electrically connected in FIG. 10. The first housing part 8 and the first sensor part 41 are connected mechanically to one another, in particular directly, as shown in FIG. 9. The second housing part 9 and the second sensor part 41 are connected mechanically to one another, in particular directly. Furthermore, the first housing part 8, with the mechanically connected first sensor part 41, and the second housing part 9, with the mechanically connected second sensor part 42 are designed for mechanical connection to one another for the arrangement of the sensor system 40 in the device housing 7, being mechanically connected and arranged in FIG. 10. Moreover, as shown in FIG. 9, the first sensor connector 43 is held fast in such a way in relation to the first housing part 8 and the second sensor connector 44 is held fast in such a way in relation to the second housing part 9 that, by means of the arrangement of the first housing part 8, with the mechanically connected first sensor part 41, and of the second housing part 9, with the mechanically connected second sensor part 42, against one another for mechanical connection to one another, the first sensor connector 43 and the second sensor connector 44 are arranged adjacent to one another, as shown in FIG. 10.

In the exemplary embodiment shown, the method furthermore has the following step: electric connection of the first sensor connector 43 and of the second sensor connector 44 to one another, in particular by the arrangement of the first housing part 8 and of the second housing part 9 against one another.

In alternative exemplary embodiments, the electric connection of the first sensor connector and of the second sensor connector to one another can be carried out after the arrangement of the first housing part and the second housing part against one another. In addition or as an alternative, the first sensor connector need not or may not be held fast in such a way in relation to the first housing part and/or the second sensor connector need not or may not be held fast in such a way in relation to the second housing part that, by means of the arrangement of the first housing part and of the second housing part against one another, the first sensor connector and the second sensor connector are arranged adjacent to one another.

The first power part 3 furthermore has an electric motor 18.

In addition, the second power part 4 has an electronic motor control system 19 and/or power electronics 20, in particular an inverter 21 and/or at least one circuit breaker 22, in particular a power transistor 23, and/or a power source interface 24, in particular a rechargeable battery interface 25, for electric connection to a power source 26, in particular a rechargeable battery pack 27, for supplying the processing device 1 with electric driving power, being connected electrically in FIG. 8.

As a further addition, the first sensor part 41 has a sensor element 45 for recording a measured variable.

As a further addition, the second sensor part 42 has sensor electronics 46 for processing the electric sensor signal.

In the exemplary embodiment shown, the first power part 3 has a processing tool interface for mechanical connection to the processing tool 30 for driving the processing tool 30, being connected mechanically in FIG. 8.

The processing device 1 furthermore has a rechargeable battery receptacle. The rechargeable battery receptacle is designed to accommodate the rechargeable battery pack 27, being accommodated in FIG. 8.

Moreover, the first housing part 8 is at least 50%, in particular 100%, made of metal ME.

In addition, the second housing part 9 is at least 50%, in particular 100%, made of plastic KS.

As the exemplary embodiments shown and described above make clear, the invention makes available a hand-held processing device and a method for producing such a hand-held processing device which has improved characteristics.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-held processing device, comprising:
an electric drive motor system comprising a first power part and a second power part, wherein the first power part has at least one first power connector and the second power part has at least one second power connector, the first power connector and the second power connector being configured for electric connection to one another in order to transfer electric driving power; and
a device housing comprising a first housing part and a second housing part, wherein the first housing part and the first power part are connected mechanically to one another and the second housing part and the second power part are connected mechanically to one another, the first housing part, with the mechanically connected first power part, and the second housing part, with the mechanically connected second power part, being configured for mechanical connection to one another for arrangement of the electric drive motor system in the device housing,
wherein the first power connector is held fast in relation to the first housing part and wherein the second power connector is held fast in relation to the second housing part such that, by way of an arrangement of the first housing part, with the mechanically connected first power part, and of the second housing part, with the mechanically connected second power part, against one another for mechanical connection to one another, the first power connector and the second power connector are arranged adjacent to one another, and
wherein the electric drive motor system has at least one fixing element, wherein the fixing element is configured to be adjustable between an enable position for enabling the arrangement of the first power connector and of the second power connector adjacent to one another and a fixing position for fixing the electric connection of the first power connector and of the second power connector to one another.

2. The hand-held processing device according to claim 1, wherein at least one of:
the first power connector is held fast in such a way and wherein the second power connector is held fast in such a way that, by way of the arrangement of the first housing part and the second housing part against one another, the first power connector and the second power connector are arranged in contact with one another and/or in each case in contact with the fixing element, or
the first power connector is held fast in such a way and wherein the second power connector is held fast in such a way that, by way of the adjustment of the fixing element between the enable position and the fixing position, the first power connector and the second power connector are arranged in contact with one another and/or in each case in contact with the fixing element.

3. The hand-held processing device according to claim 1, wherein
the fixing element is not configured for adjustment between the enable position and the fixing position by the arrangement of the first housing part and the second housing part against one another and/or of the first power connector and the second power connector adjacent to one another.

4. The hand-held processing device according to claim 1, wherein
the fixing element is a screw.

5. The hand-held processing device according to claim 1, wherein at least one of:
the first power connector has insertion prongs for reception of a part of the fixing element in the enable position during arrangement, or
the second power connector has insertion prongs for reception of a part of the fixing element in the enable position during arrangement.

6. The hand-held processing device according to claim 1, wherein at least one of:
the first power connector and the fixing element are configured such that the first power connector and the fixing element are secured against release from one another in the fixing position by positive engagement, or
the second power connector and the fixing element are configured such that the second power connector and the fixing element are secured against release from one another in the fixing position by positive engagement.

7. The hand-held processing device according to claim 1, wherein
the device housing has a closable access opening for electrically connecting the first power connector and the second power connector to one another and/or for adjusting the fixing element.

8. The hand-held processing device according to claim 1, wherein
the first housing part and the second housing part are configured for arrangement against one another in an arrangement direction, and
the fixing element is configured to be adjustable between the enable position and the fixing position in an adjustment direction nonparallel to the arrangement direction.

9. The hand-held processing device according to claim 8, wherein
the first power connector has a first contact surface, and the second power connector has a second contact surface for electric connection to one another,
the first contact surface of the first power connector is aligned non-orthogonally to the arrangement direction, and
wherein the second contact surface of the second power connector is aligned non-orthogonally to the arrangement direction.

10. The hand-held processing device according to claim 1, wherein
the first power connector has a first contact surface, and the second power connector has a second contact surface for electric connection to one another,
the first contact surface of the first power connector is aligned non-orthogonally to the arrangement direction, and
wherein the second contact surface of the second power connector is aligned non-orthogonally to the arrangement direction.

11. The hand-held processing device according to claim 9, wherein
the first contact surface of the first power connector is aligned in such a way and the second contact surface of the second power connector is aligned in such a way that, owing to the arrangement of the first housing part and of the second housing part against one another, the first contact surface and the second contact surface overlap in an overlap direction non-orthogonal to the arrangement direction.

12. The hand-held processing device according to claim 1, wherein at least one of:
the first power connector has a first contact tongue, or
the second power connector has a second contact tongue.

13. The hand-held processing device according to claim 1, further comprising:
a sensor system comprising a first sensor part and a second sensor part, wherein the first sensor part has at least one first sensor connector and the second sensor part has at least one second sensor connector, the first sensor connector and the second sensor connector being configured for electric connection to one another in order to transfer an electric sensor signal,
wherein the first housing part and the first sensor part are connected mechanically to one another and the second housing part and the second sensor part are connected mechanically to one another, wherein the first housing part, with the mechanically connected first sensor part, and the second housing part, with the mechanically connected second sensor part, are configured for mechanical connection to one another for arrangement of the sensor system in the device housing, and
wherein the first sensor connector is held fast in relation to the first housing part and the second sensor connector is held fast in relation to the second housing part such that, by way of the arrangement of the first housing part, with the mechanically connected first sensor part, and of the second housing part, with the mechanically connected second sensor part, against one another for mechanical connection to one another, the first sensor connector and the second sensor connector are arranged adjacent to one another.

14. The hand-held processing device according to claim 13, wherein at least one of:
the first power part has an electric motor,
the second power part has motor control electronics, power electronics, an inverter, a circuit breaker, a power transistor, a power source interface, or a rechargeable battery interface, for electric connection to a power source, for supplying the processing device with electric driving power,
the first sensor part has a sensor element for recording a measured variable, or
the second sensor part has sensor electronics for processing an electric sensor signal.

15. The hand-held processing device according to claim 1, wherein at least one of:
the first housing part is at least 50% made of metal, or
the second housing part is at least 50% made of plastic.

16. The hand-held processing device according to claim 1, wherein at least one of:
the first housing part is 100% made of metal, or
the second housing part is 100% made of plastic.

17. The hand-held processing device according to claim 1, wherein
the first housing part and the second housing part are configured for arrangement against one another in an arrangement direction nonparallel to a longitudinal axis of the processing device.

18. A method for producing a hand-held processing device, wherein the hand-held processing device comprises:
an electric drive motor system comprising a first power part and a second power part, wherein the first power part has at least one first power connector and the second power part has at least one second power connector, the first power connector and the second power connector being configured for electric connection to one another in order to transfer electric driving power; and
a device housing comprising a first housing part and a second housing part, wherein the first housing part and the first power part are connected mechanically to one another and the second housing part and the second power part are connected mechanically to one another, the first housing part, with the mechanically connected first power part, and the second housing part, with the mechanically connected second power part, being configured for mechanical connection to one another for arrangement of the electric drive motor system in the device housing,
wherein the first power connector is held fast in relation to the first housing part and the second power connector is held fast in relation to the second housing part such that, by way of an arrangement of the first housing part, with the mechanically connected first power part, and of the second housing part, with the mechanically connected second power part, against one another for mechanical connection to one another, the first power connector and the second power connector are arranged adjacent to one another, and
wherein the electric drive motor system has at least one fixing element, wherein the fixing element is configured to be adjustable between an enable position for enabling the arrangement of the first power connector and of the second power connector adjacent to one another and a fixing position for fixing the electric connection of the first power connector and of the second power connector to one another,
wherein the method comprises the steps of:
a) arranging the first housing part, with the mechanically connected first power part, and the second housing part, with the mechanically connected second power part, against one another; and
b) adjusting the fixing element between the enable position and the fixing position.
